(19) United States
(12) Patent Application Publication
(10) Pub. No.: US 2003/0164564 A1
(43) Pub. Date: Sep. 4, 2003

(54) Method and apparatus for producing thick-walled molded parts

(75) Inventor: Bernd Klotz, Gunding/Bergkirchen (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTOFFTECHNIK GMBH, Munchen (DE)

(21) Appl. No.: 10/403,545

(22) Filed: Mar. 31, 2003

Related U.S. Application Data
(63) Continuation of application No. PCT/EP01/11262, filed on Sep. 28, 2001.

(30) Foreign Application Priority Data
Oct. 2, 2002 (DE) 100 48 861.7

(51) Int. Cl. B29C 43/04; B29D 11/00

(52) U.S. Cl. 264/2.2; 425/808; 425/352; 425/572; 264/328.7

(57) ABSTRACT

The invention relates to a method and apparatus for making thick-walled plastic parts, in particular blanks for optical lenses. In accordance with the invention, a two-phase production process is proposed in order to make thick-walled lenses with high optical quality and homogenous material properties, wherein in a first phase, a thin lens is first made through injection molding, and in a second step the lens is enlarged, i.e. “inflated”, until the final thickness through continued injection of plastic material.

### CROSS-REFERENCES TO RELATED APPLICATIONS

This application is a continuation-in-part of prior filed copending PCT International application no. PCT/EP01/11262, filed Sep. 28, 2001, which designated the United States and on which priority is claimed under 35 U.S.C. §120, the disclosure of which is hereby incorporated by reference.

This application claims the priority of German Patent Application, Serial No. 100 48 861.7, filed Oct. 2, 2000, pursuant to 35 U.S.C. 119(a)-(d), the disclosure of which is incorporated herein by reference.

### BACKGROUND OF THE INVENTION

The present invention relates to a method and apparatus for producing thick-walled molded parts.

Such “thick-walled molded parts” involve spectacle glasses which are made of glass, on the one hand, and increasingly also of plastic, on the other hand. Hereby, for example, duroplastic casting compounds (CR 39) and thermoplastic material is used. Depending on use, polystyrene (PS), polymethylmethacrylate (PMMA) or polycarbonate (PC) are used; PC is, however, increasingly used in view of the high impact strength.

Conventional methods produce lens blanks of uniform wall thickness (1.5-3 mm) in cycle times of below 30 s, normally employing the standard injection molding process. The plastic mass is introduced in the charging phase via small-sized channels into the lens cavity. As amorphous plastics undergo a high density reduction (10-20%) in the cooling phase, this shrinkage in material is compensated in a subsequent afterpressure phase by adding plastic melt from the injection piston of the injection molding machine.

In contrast to the standard injection molding process, a standard injection compression process introduces the plastic mass in a first charging phase in a cavity of initially enlarged size, and this plastic mass is then compressed by means of an axial mold compression. The mass weight, introduced in the first charging phase in the initially enlarged cavity corresponds hereby to the mass weight of the parts being removed later. The axial die movement, which can be initiated through die technique as well as machine technique, the pre-enlarged cavity is reduced in size and the rest of the cavity is filled. The standard injection compression process is employed for simple optical articles such as lenses, to prevent sink marks as a result of material shrinkage.

In order to avoid joint lines in lenses with negative refractive index (inside thin, outside thick), European Pat. No. EP 0 144 622 and U.S. Pat. No. 4,540,534 propose to introduce the plastic mass in a first charging phase into an initially enlarged cavity until the latter is completely filled. Subsequently, an axial die movement is initiated, and the initially enlarged cavity is decreased in size. A defined amount of plastic mass is hereby displaced out of the cavity. Otherwise, the procedure corresponds to the standard injection compression process.

A corresponding procedure is proposed by U.S. Pat. No. 4,828,769, in which the compression phase starts before the first injection phase is over. Also this process may be used for optical parts; a known application involves the manufacture of DVD.

Although the afore-mentioned methods yield satisfactory results in conjunction with the manufacture of thin-walled molded plastic parts, for example, thin lenses, significant problems are encountered when making thick-walled molded parts or lenses. For example, sink marks may be experienced as a result of material shrinkage, or surface marks may develop because the plastic mass cannot flow by way of an optimum frontal flow into the cavity. Hereby, the term “frontal flow” relates to a melt flow within a mold and implies an execution of a molding operation in a way that a flow of melt is maintained. Another drawback of conventional methods resides in the fact that cold marginal layers may shift in the charging phase. Although an increase of the die temperature to near glass transition temperature (TG=approx. 140° C. for PC) suppresses the generation of cold marginal layers, this is accompanied by a prolonged cycle time.

In order to ensure a substantially optimal frontal flow, large gates are required which must subsequently be severed in a dust-free manner and normally are no longer used for the manufacture of optical parts and must be disposed of as waste.

In order to realize a good molding of the die cavity surface, a high die temperature has to be selected for the charging phase. The die temperature is near the glass transition temperature of the plastic, resulting in high energy consumption.

It would therefore be desirable and advantageous to provide an improved method of making thick-walled molded parts, in particular optical lenses, which obviates prior art shortcomings and which is easy and economically to control and enables the manufacture of plastic molded parts with optimum surface finish.

### SUMMARY OF THE INVENTION

According to one aspect of the present invention, a method of making thick-walled molded plastic parts, in particular thick-walled optical lenses, through provision of a die with variable cavity, includes the steps of closing the die and adjusting the cavity to a first size which corresponds to the dimension of a thin-walled molded part, injecting plastic material to completely charge the cavity, while maintaining the first size of the cavity, continuing to inject plastic material, while expanding the cavity to a second size which is greater than the first size and corresponds to the dimension of a desired thick-walled molded plastic part, forming a thick-walled molded plastic part, and opening the die and removing the thick-walled molded plastic part.

The method according to the invention exploits the knowledge that the manufacture of relatively thin-walled molded plastic parts can be implemented fairly easily while realizing good surface finish. Accordingly, this recognition is applied to thick-walled molded parts, and the method according to the invention is divided into two phases. In the first phase, a relatively thin part with optimum surface quality is produced, and in a second phase, the molded plastic part is “inflated” to a final wall thickness through introduction of plastic material.

In accordance with the invention, after the first phase or also after the second phase, a compression ram is used which is linearly movable and defines part of the cavity. Hereby, the compression ram is preferably isolated in the area of its molding end in parallel relationship to its movement path from the wall of a molding die through injected plastic material. Therefore, it is not necessary, to maintain the molding die in this phase at elevated temperature.

On the other hand, cooling effects cannot be completely avoided in the cavity, so that the resultant internal pressure would decrease, when using a clamping force profile that is dependent on a screw path or closing path. Therefore, it is proposed in accordance with the invention to use a clamping force profile that is controlled by the internal pressure.

According to another aspect of the present invention, an apparatus for making thick-walled molded plastic parts, in particular thick-walled optical lenses, includes a first die platen, a second die platen, and a compression ram which is movable linearly in one of the die platens via an adjustable stroke, and which together with the first and second die platens define a variable cavity, wherein in a first position of the compression ram, the cavity has a minimum size, wherein at least one of the die platens has a groove which surrounds an end of the compression ram, with the groove extending at least along the stroke of the compression ram in parallel relationship to a movement path of the compression ram and communicating with the cavity.

The present invention resolves prior art shortcomings by surrounding at least the cavity-proximal end of the compression ram by a hollow space which is in communication with the cavity and in which injected plastic material migrates. This hollow space extends at least along the stroke of the movable compression ram so that the compression ram is isolated from the die at least in the area of the migrated plastic material.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic cross sectional illustration of a molding die according to the present invention;

FIG. 2A is a cross sectional view of the molding die in a first position;

FIG. 2B is a cross sectional view of the molding die in a second position;

FIG. 3 shows a process sequence diagram of one variation of a molding process in accordance with the present invention; and

FIG. 4 shows a process sequence diagram of one variation of a molding process in accordance with the present invention.

### DETAILED DESCRIPTION OF PREFERRED EMBODIMENTS

Throughout all the FIGS., same or corresponding elements are generally indicated by same reference numerals. These depicted embodiments are to be understood as illustrative of the invention and not as limiting in any way.

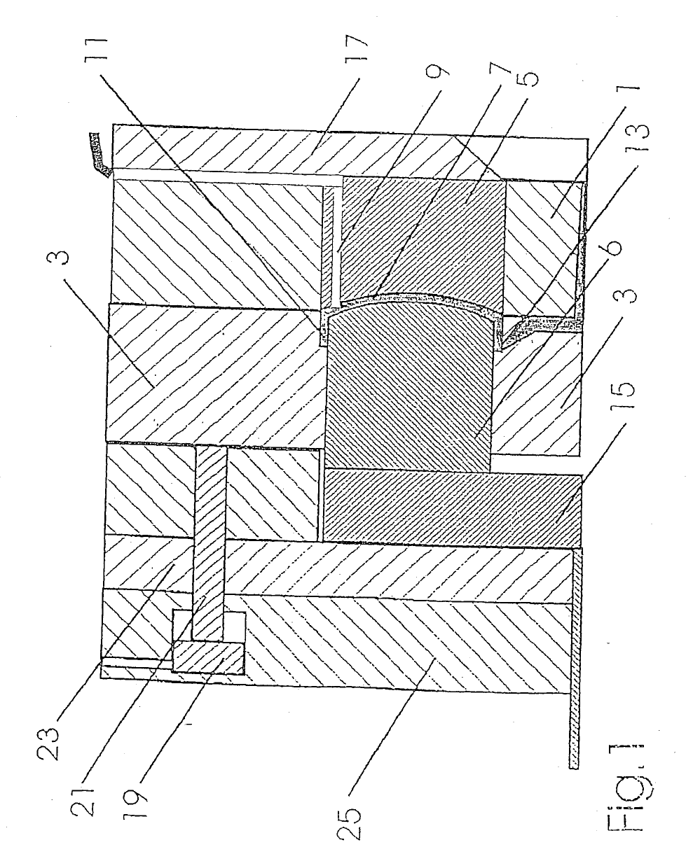

Turning now to the drawing, and in particular to FIG. 1, there is shown a schematic cross sectional illustration of a molding die according to the present invention, including a first die platen 1 in which a lens blank 5 is placed. The first die platen 1 is supported by a support plate 17. A second die platen 3 interacts with the first die platen 1 and carries a compression ram 6 which is movable in axial direction (vertical direction of FIG. 1) via a driving plate 15. The lens blank 5, the second die platen 3 and the compression ram 6 define together a cavity 7 which is supplied with liquid plastic material via a sprue 13. Hereby, plastic material migrates in particular also into a lateral zone 11 between the die platen 3 and the compression ram 6 and insulates the cavity-proximal end of the compression ram 6 from the heated die. The material in this zone forms thus in a way an “insulation edge”.

While the cavity 7 is charged, the die platen 3 is held by a hydraulic piston and cylinder unit 19, 21 against the die platen 1 to prevent an opening of the die during the charging process.

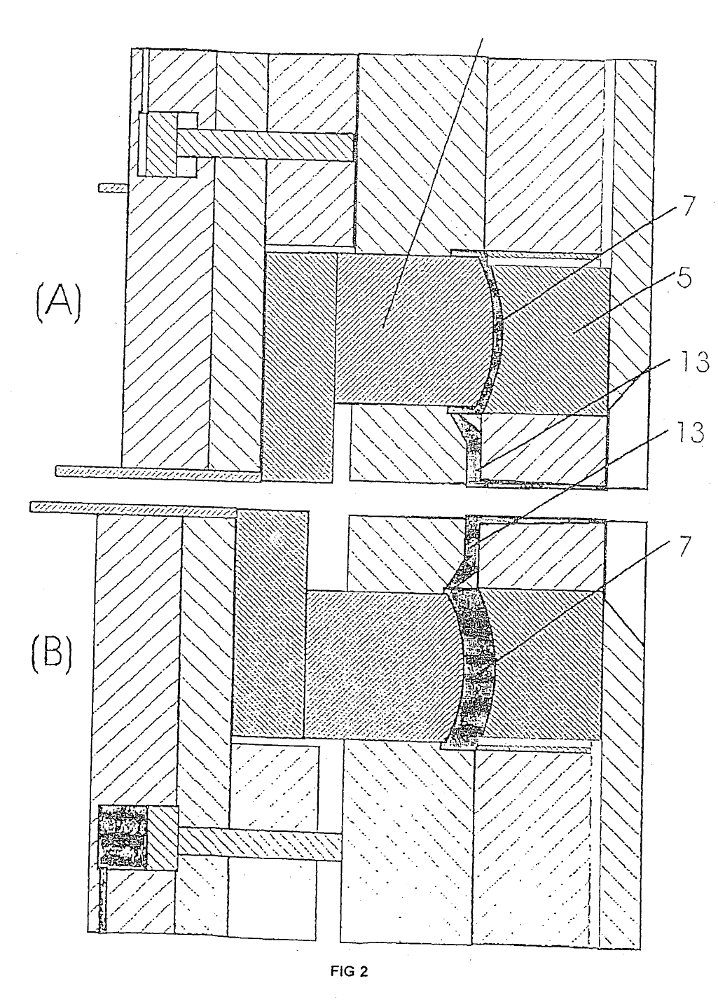

FIGS. 2A, B show the compression ram 6 of the molding die of FIG. 1 in two different positions. In the position of FIG. 2A, the compression ram 6 is so adjusted that the cavity 7 has a minimum size, whereas in the position of the compression ram 6 in FIG. 2B, the cavity 7 of the die has a maximum size.

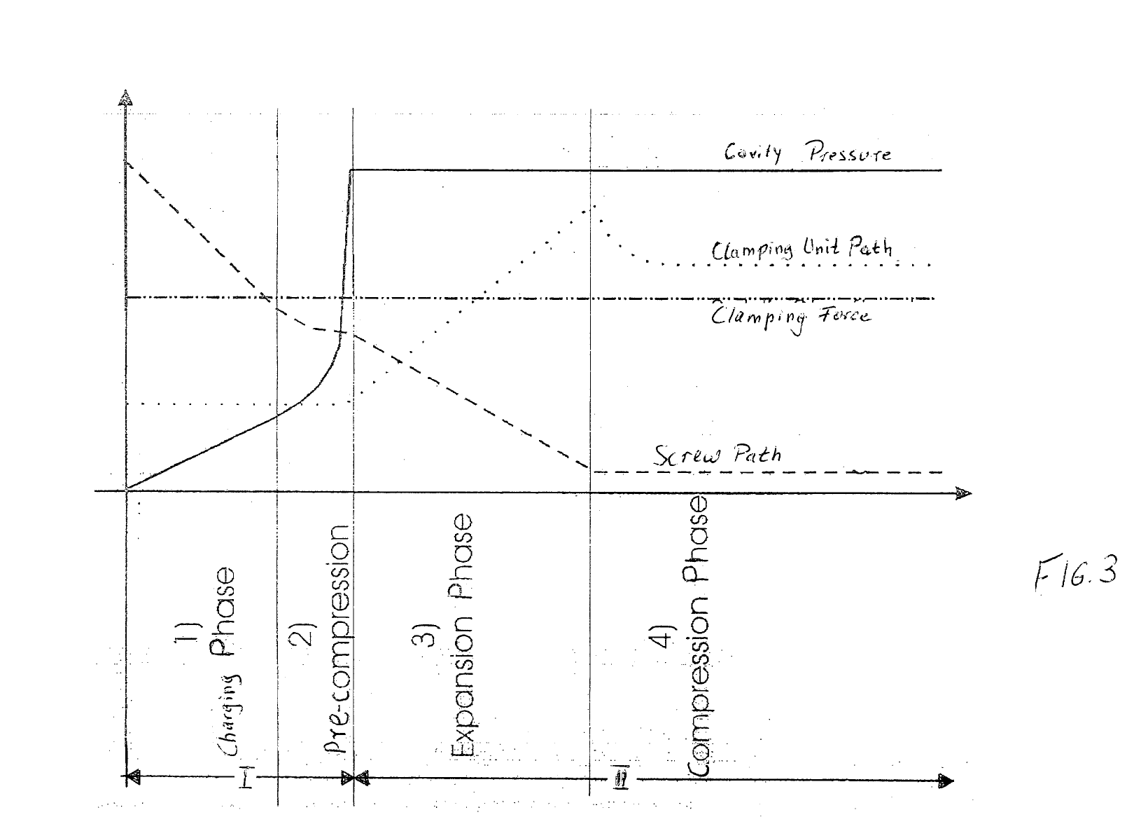

A first variation of the molding process sequence will now be described with reference to FIG. 3. In a first process phase I, including a charging phase (1), in which the die is completely closed, and plasticized plastic material is introduced into the cavity 7 of minimum size by an injection cylinder or screw of an injection molding machine, until the cavity 7 of minimum size is completely charged. Thereafter, an optional short pre-compression phase (2) follows to mold in an optimum manner the surface at high cavity pressure.

Subsequently, in a second process phase II, including an expansion phase (3) in which the compression ram 6 is moved away from the die platen 1 to expand the cavity 7 to maximum size so that the plastic mass is “inflated” by the injection cylinder of the injection molding machine until reaching a defined wall thickness, optionally in dependence of the screw path or clamping unit path. The expansion phase (3) is followed by a compression phase (4) in which a mass compression is executed to prevent sink marks as a result of material shrinkage. After molding the molded plastic part, the die is opened and the molded plastic part is removed, followed by another cycle.

The provision of the insulation edge 11 according to the invention results in an insulation of the compression ram 6 from the heated die so as to be movable in axial direction for a long time. The thickness of the insulation edge 11 is dependent on the thickness of the part and the resultant cycle time (oftentimes 6 min. and longer). Without insulation edge or a situation in which the insulation edge is too thin, the compression ram. 6 would be decelerated by the forming cold marginal layer on the outer lens edge and would then no longer be compressible in axial direction. The consequence is the formation of sink marks as a result of material shrinkage.

Formation of sink marks can additionally be prevented by maintaining the internal pressure of the cavity as constant as possible. For that reason, an internal pressure generator 9 is provided, as indicated in FIG. 1, so that the process can be controlled in dependence on the cavity pressure.

The method according to the invention has diverse advantages in comparison to the prior art. As a consequence of the concluding compression phase (4), the process step does not encounter any material shrinkage and thus formation of sink marks.

In view of the final compression phase (4), the compression ram 6 avoids the formation of sink marks across the entire surface and applies the internal pressure across the entire surface of the lens blank 5. It is thus sufficient to make a lens at slight internal pressure and therefore at little trapped stress.

In conventional processes, the typical die temperature for injection molding thin lenses (2-3 mm) in PC amount to 80° C., while the molding of thick lenses (13 mm) requires a temperature of about 120° C. This temperature of about 120° C. is required to prevent the defects such as “shift of cold marginal layers” and lack in surface brilliancy. The die temperature should therefore approach the glass transition temperature as close as possible during the charging phase. As a result, the cycle time is conventionally long, frequently more than 6 minutes.

The provision of such a high die temperature can now be eliminated by the method according to the present invention. As shown in FIG. 3, an internal pressure is building up in the cavity already in the charging phase (1) as a result of the filling resistance. Already at die temperatures of about 80° C. (with PC), there is no shift of cold marginal layers, and an optimum surface structure is realized and therefore a high surface brilliancy. A reduction of the cycle time of up to 50% can be attained.

As a consequence of the thin wall thicknesses of the reduced size of the cavity 7, an optimum frontal flow is implemented even when low-viscose plastics are involved. Therefore, it is possible to apply small gates (pin-point gate, tunnel gate). The cold channel can thus easily be separated from the lens after removal of the part (pin-point gate). Taking the example of tunnel gate, an automatic separation of the cold channel is also possible during opening of the die.

Since there is absolutely no need for the compensation of shrinkage by the injection cylinder of the injection molding machine, and the process steps up to the final compression are executed within a short time (7seconds), small cold channel cross sections can be used. Typically, a cold channel thickness is used which corresponds to the thickness of the initially reduced cavity. The lens thickness is made in the process step (3), i.e. the expansion of the thin lens. The resultant lens thickness is realized as a function of the amount of injected plastic. Thus, it is not necessary, to change inserts in the die to modify the wall thickness of the parts, so that a plurality of lens thicknesses can be manufactured in a die.

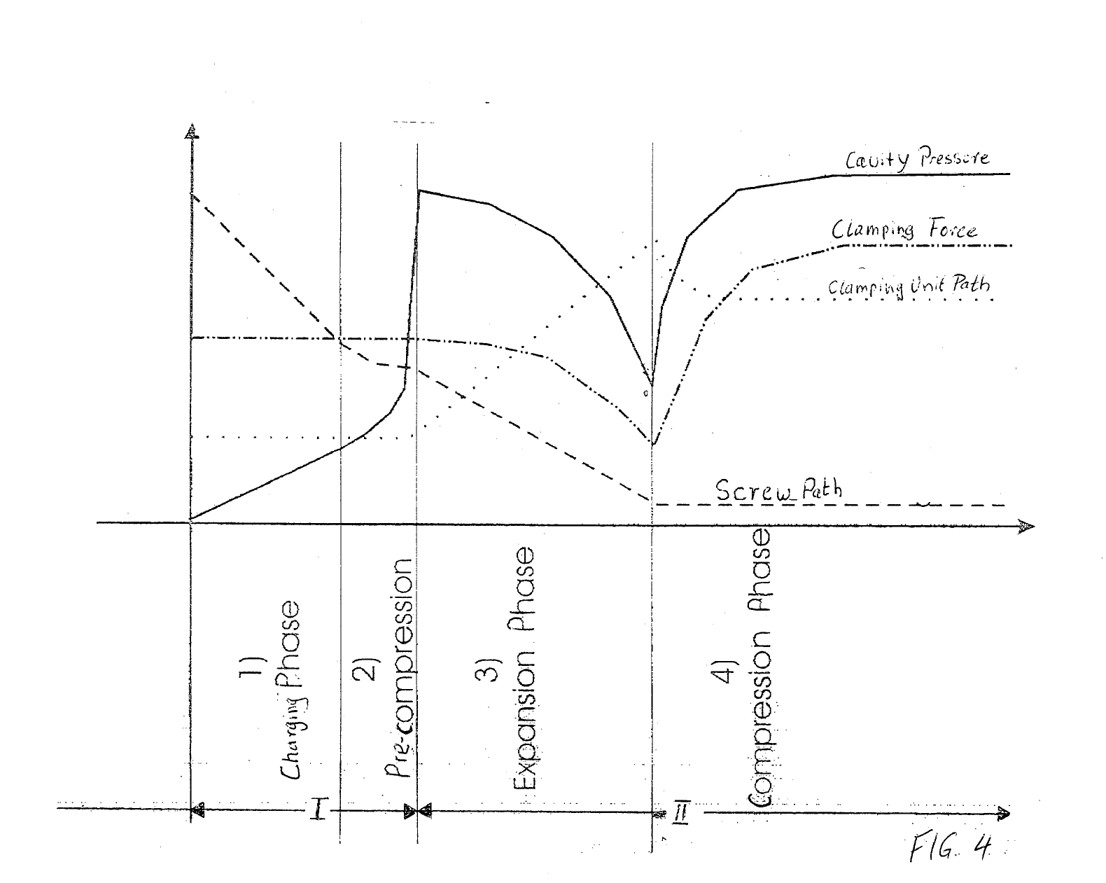

In contrast to the variation of FIG. 3, it is also possible to change the cavity pressure profile and the clamping force profile, as shown in FIG. 4. While the process phase I corresponds to the process phase I of the variation of FIG. 3, the process phase II of the process sequence of FIG. 4 differs from FIG. 3 by decreasing the clamping force in the expansion phase (3), resulting in a parallel drop of the cavity pressure, and by increasing the clamping force again in the compression phase (4), resulting in a parallel increase in cavity pressure.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of making thick-walled molded plastic parts, in particular thick-walled optical lenses, through provision of a die with variable cavity, comprising the steps of:
a) closing the die and adjusting the cavity to a first size which corresponds to the dimension of a thin-walled molded part;
b) injecting plastic material to completely charge the cavity, while maintaining the first size of the cavity;
c) continuing to inject plastic material, while expanding the cavity to a second size which is greater than the first size and corresponds to the dimension of a desired thick-walled molded plastic part,
d) forming a thick-walled molded plastic part; and
e) opening the die and removing the thick-walled molded plastic part.

2. The method of claim 1, and further comprising the step of compressing the plastic material between the steps (b) and (c).

3. The method of claim 1, and further comprising the step of compressing the plastic material after the step (d).

4. The method of claim 1, wherein the size of the cavity is changed by a linearly movable compression ram having one end to define a thickness of the cavity and is laterally thermally insulated by injected plastic material from a die half at least along a stroke of the compression ram.

5. The method of claim 1, and further comprising the steps of determining a cavity pressure and using a clamping force profile which is controlled in dependence on the cavity pressure.

6. The method of claim 5, wherein the cavity pressure and the clamping force are kept constant during the step c).

7. The method of claim 5, and further comprising the step of compressing the plastic material after the step (d), wherein the clamping force and the cavity pressure decrease during the step (c) and increase during the compressing step.

8. A method of making a plastic part; comprising the steps of:
injecting plastic material into a cavity of a die in a first process phase, while maintaining the cavity at a first size; and
continuing to inject plastic material into the cavity in a second process phase while expanding the cavity to a second size which is greater than the first size to form a finished article.

9. The method of claim 8, and further comprising the step of compressing the plastic material after the injecting step.

10. The method of claim 8, and further comprising the step of compressing the plastic material after the expanding step.

11. The method of claim 8, wherein the second process phase is carried out at constant cavity pressure and constant clamping force.

12. The method of claim 8, and further comprising the step of compressing the plastic material after the expanding step, wherein the second process phase is carried out by a decrease in clamping force and cavity pressure decrease during the expanding step, and by an increase during the compressing step.

13. Apparatus for making thick-walled molded plastic parts, in particular thick-walled optical lenses, comprising:
a first die platen;
second die platen; and
a compression ram which is movable linearly in one of the die platens via an adjustable stroke, and which together with the first and second die platens defines a variable cavity, wherein in a first position of the compression ram, the cavity has a minimum size,
wherein at least one of the die platens has a groove which surrounds an end of the compression ram, said groove extending at least along the stroke of the compression ram in parallel relationship to a movement path of the compression ram and communicating with the cavity.

14. Apparatus for making a plastic part, comprising:
a first die platen;
second die platen; and
a compression ram which together with the first and second die platens defines a cavity for receiving plastic material, said compression ram being movably received in one of the die platens for adjusting a size of the cavity between a minimum size and a maximum size,
wherein at least one of the die platens has a groove which surrounds a cavity-proximate end of the compression ram and is fluidly connected to the cavity to receive plastic material to thereby insulate the cavity-proximate end of the compression ram from the die platens.

15. The apparatus of claim 14, wherein the groove extends in parallel relationship to a movement path of the compression ram.
